(19) United States
(12) Patent Application Publication
(10) Pub. No.: US 2016/0151848 A1
(43) Pub. Date: Jun. 2, 2016

(54) WIRE ELECTRODE FOR ELECTRICAL DISCHARGE MACHINING

(71) Applicant: Dandridge Tomalin, Mason, OH (US)

(72) Inventor: Dandridge Tomalin, Mason, OH (US)

(21) Appl. No.: 14/427,819

(22) PCT Filed: Jun. 7, 2013
(86) PCT No.: PCT/US13/44735

§ 371 Date: Mar. 12, 2015

Related U.S. Application Data
(60) Provisional application No. 61/701,933, filed on Sep. 17, 2012.

(51) Int. Cl. B23H 1/06; B23K 35/02

(52) U.S. Cl. CPC B23H 1/06; B23K 35/02

(57) ABSTRACT

A gamma phase brass coated EDM wire electrode is processed to produce distinct particulate of the brittle gamma phase alloy where these particulate have a uniquely describable distribution of geometric parameters. The distribution of particles determined by analyzing random cross sections of the wire electrode using standard optical metallographic procedures contains a minimum number of particles with a minor axis of less than 1.5 μm and a higher proportion of larger aspect ratio (quotient of the values of major axis and minor axis] particles. Such wire electrodes are found to contain less loose debris than electrodes described in the prior art, i.e. are cleaner than prior art gamma wires without suffering any degradation in cutting speed performance.

### RELATED APPLICATIONS

This application claims priority from U.S. Provisional Application No. 61/701,933, filed Sep. 17, 2012, the entirety of which is incorporated herein by reference.

### TECHNICAL FIELD

The present invention relates generally to electrical discharge machining and in particular to a new and improved wire electrode for use in electrical discharge machining

### BACKGROUND ART

A considerable volume of prior art regarding the construction of wire electrodes for electrical discharge machining has been has been well documented in the patent literature (for example see U.S. Pat. No. 5,945,010), the most recent advance being the introduction of coatings containing gamma phase brass alloy. However, it is very unfortunate that the prior art patent literature for gamma phase coating technology contains confusing and misleading technical data which has not advanced the technology to its full potential.

Barthel et al were the first to identify the potential of gamma phase brass coatings in their U.S. Pat. No. 6,447,930 but unfortunately the process they described produced a continuous and pure gamma phase coating which is only achievable under very limited conditions. In U.S. Pat. No. 5,945,010 Tomalin recognized the fact gamma phase brass is very brittle and will produce a discontinuous coating if the wire is cold drawn after the gamma phase brass is synthesized from the diffusion of zinc into brass or copper. Groos et al identified the optimum geometric characteristics for a superior two phase double layered coating of gamma and beta phases of brass in U.S. Pat. No. 6,781,081, but unfortunately they do not identify the wire processing parameters that were used to generate the results that were purportedly achieved. They claimed the critical geometric parameters that produce optimum wire cutting performance are the ratio of the thicknesses of the two phases and the sum of their combined thickness. The data they present in support of their thesis (FIGS. 2 and 3) are highly suspect since it is physically impossible to produce some of the gamma brass coated wires they report data for, namely gamma brass coated wires with a coating thickness in excess of 10 μm. This is because if a continuous coating were to be synthesized at the finish wire diameter of 0.3 mm, a wire with a coating thickness of 10 μm would be too brittle to handle in the wire feeding mechanism of an EDM machine tool. Alternatively if a gamma phase brass coating were to be synthesized by forming gamma phase at an intermediate wire diameter and drawing such a wire to a finished diameter of 0.3 mm, it would be impossible to generate a gamma coating layer thickness of 10 μm or larger because the brittle gamma layer would fracture into multiple particles and it would be impossible to adhere a coating layer greater than approximately 5-6 μm. In point of fact the loose or loosened gamma phase brass particles making up the coating would readily spall off the coating thereby creating such an excess of powder on the machine tool that the wire guides would quickly become packed with powder and the machine tool would shut down due to wire breakage.

### DISCLOSURE OF THE INVENTION

The present invention provides a new and improved wire electrode for an electrical discharge machining process.

According to the invention, the electrode wire includes a core that is comprised of one of a metal, an alloy of a metal and/or a metallic multi-layered composite. A coating is disposed on the core that comprises distinct particulate of a brittle alloy. The particulate possesses a range of geometric parameters, i.e., major axes, minor axes and aspect ratio. According to the invention, the aspect ratio is defined by the quotient of the division of the major axes dimension by the minor axes dimension. A distribution of the geometric parameters is determined by five full circumference random optical metallurgical cross sections seen at a magnification of a minimum 1000 times. The distribution contains a maximum 15% number of particles with a minor axes equal to or less than 1.5 micro meters and a minimum of 10% number of particles with an aspect ratio equal to or greater than 5.0.

In one disclosed embodiment, the core is copper, whereas in another embodiment the core is an alloy of brass. In a third embodiment, the core is a multi-layered composite.

According to the invention, when the electrode wire core is constructed from a metallic multi-layered composite, the core is preferably a copper core with an outer layer of beta phase brass. In another disclosed construction of this embodiment, the multi-layered composite core is an alpha phase brass core with an outer layer of beta phase brass. In still another construction of this embodiment, the metallic multi-layered composite core is a steel core with an intermediate layer of copper and an outer layer of beta phase brass. In another construction of this embodiment, the multi-layered composite core is a steel core with a first intermediate layer of copper, a second intermediate layer of alpha phase brass and an outer layer of beta phase brass.

In one disclosed embodiment, the coating that is disposed on the core is gamma phase brass.

It is the object of this invention to identify the geometric parameters of gamma phase brass coatings that will maintain superior wire cutting speeds while simultaneously providing a cleaner wire which requires less machine maintenance.

According to the invention, this objective is met when the processing parameters are adjusted such that the particles comprising the gamma phase coating predominantly have a minor axis greater than 1.5 μm and the value of the ratio of their major axis to minor axis is significantly greater than 2-4. Surprisingly when these conditions are satisfied, a coating with a “thickness” less than that of a similar wire can maintain the same cutting speed of the wire with the thicker coating thickness while exhibiting significantly fewer debris particles which must be removed from the machine tool during periodic maintenance.

Additional features of the invention and a fuller understanding will be obtained by reading the following detailed description made in connection with the accompanying drawings,

### BRIEF DESCRIPTION OF DRAWINGS

FIG. 1a metallurgical cross section of a gamma coated brass wire prepared according to Example 1 (a process similar to that described in the prior art of U.S. Pat. No. 5,945,010).

FIG. 2 a metallurgical cross section of a gamma coated brass wire prepared by a modified process, Example 2, producing predominantly high aspect ratio gamma phase brass particles.

FIG. 3 a histogram of the distribution of resultant values minor axes generated by Example 1 (1.2 mm conversion).

FIG. 4 a histogram of the distribution of resultant values minor axes generated by Example 2 (0.4 mm conversion).

FIG. 5 a schematic diagram of the apparatus used to determine the amount of residual debris associated with a given wire type.

### DETAILED DESCRIPTION OF THE INVENTION

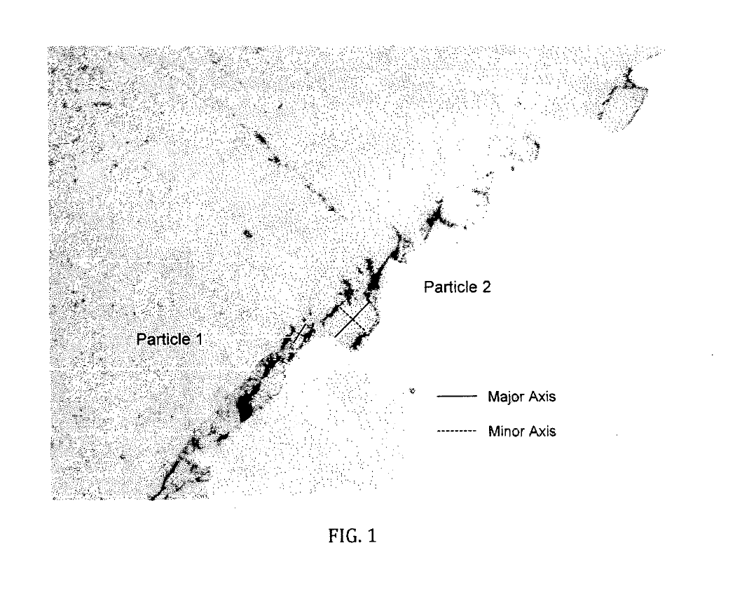

It is known that an EDM wire will cut more efficiently if it contains zinc and typically, the higher the zinc content contained in the surface, the higher the cutting speed achieved if other parameters are equivalent. It is also known that the high zinc content brass phase alloys commonly used in the EDM application also must have a relatively high melting point to be effective which explains why gamma phase brass alloy coated EDM wire has emerged as the highest performance EDM wires currently available. However, the high performance of gamma phase brass coated wire electrodes also has some limitations which are imposed by the inherent brittleness of such coatings. Since the majority of applications in EDM tend to be facilitated by higher tensile strength wires, most gamma phase brass alloy coated wires are found to be significantly work hardened or only moderately annealed. Therefore the coatings of these wires are typically composed of discrete gamma phase brass particles which form a somewhat uneven and discontinuous coating as illustrated in FIG. 1. The process for generating the microstructure described in FIG. 1 is defined in Example 1 below and is very similar to that used in the prior art cited in U.S. Pat. No. 5,945,010.

### Example 1

Core: CuZn35 Galvanizing 12 μm at 1.2 mm diameter

Anneal: 177° C. for 4 hours in air

RT Draw to 0.25 mm diameter

In the process of preparing the following metallographic cross sections such as the one depicted in FIG. 1, the wire sample was first electroplated with copper to provide a means of preventing rounding of the edge and thereby providing a clear understanding of the metallographic structure at the surface. In addition to this benefit, the copper layer also provided a clear color contrast between the components on the wire surface and the mounting material. This greatly facilitated subsequent analyses of the cross sections but unfortunately that advantage is lost in black and white reproductions. Considering FIG. 1, it is not at all clear how one would define the thickness of the gamma phase brass coating. However that is exactly the parameter those in the prior art have attempted to use to define the optimum wire coating as in U.S. Pat. No. 6,781,081. If we examine FIG. 1 further there are some hints as to what might be more precise parameters that could be used to clearly describe a higher performing wire electrode for the EDM application. Note that in FIG. 1 there are extreme variations in the parameters minor axis, major axis, and aspect ratio (minor axis/major axis) of the gamma phase brass particles such as those identified as Particle 1 and Particle 2. For example Particle 1 has a minor axis of approximately 3μ and an aspect ratio of approximately 3 whereas Particle 2 has a minor axis of approximately 9μ and an aspect ratio of approximately 1. If there are a significant number of particles with a minimal minor axis dimension, and further if those same particles had an aspect ratio approaching 1.0, that population of particles would have minimal bonding forces holding them on the surface and could be subject to being dislodged from the surface as the wire travels through the wire handling system on the machine tool as it is being delivered to and exiting from the gap of the process where the actual metal removal from the workpiece is occurring. Once dislodged from the wire, such particles become “debris” on the machine tool which can adversely affect both the performance and maintenance of the machine tool. As such debris collects in the wire guides, it can pack into the guide eventually creating enough friction to fracture the wire electrode. Therefore EDM machine tools must be periodically cleaned to prevent premature wire breaks and a preventive maintenance schedule is generally adopted for all machine tools. Obviously one would prefer to minimize the maintenance time to maximize the machining time which therefore increases the desirability of debris free wires commonly referred to in the industry as “clean” wires.

Although gamma phase brass coatings are inherently brittle, it is possible to control the distribution and morphology of the resultant particles after cold drawing by adjusting the process parameters. Example 2 provides a process schedule with significant variation from that employed in Example 1.

### Example 2

Core: CuZn35 Galvanized 12 μm at 1.2 mm diameter

RT draw to 0.4 mm diameter

Anneal 177° C. for 2 hours in air

RT draw to 0.25 mm diameter

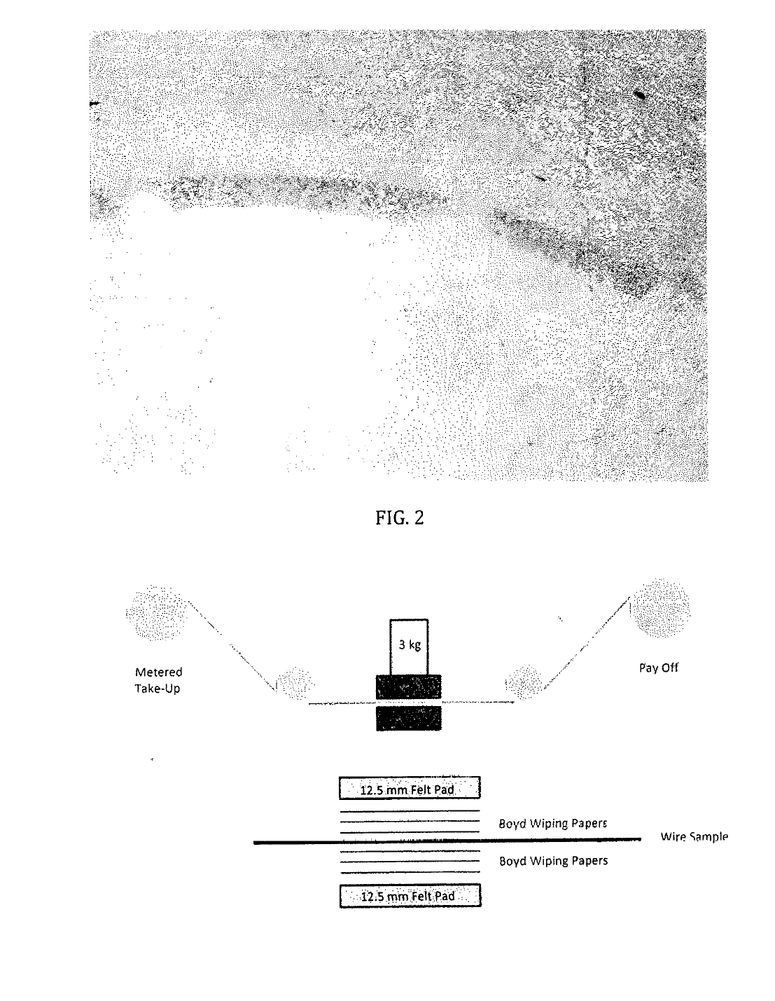

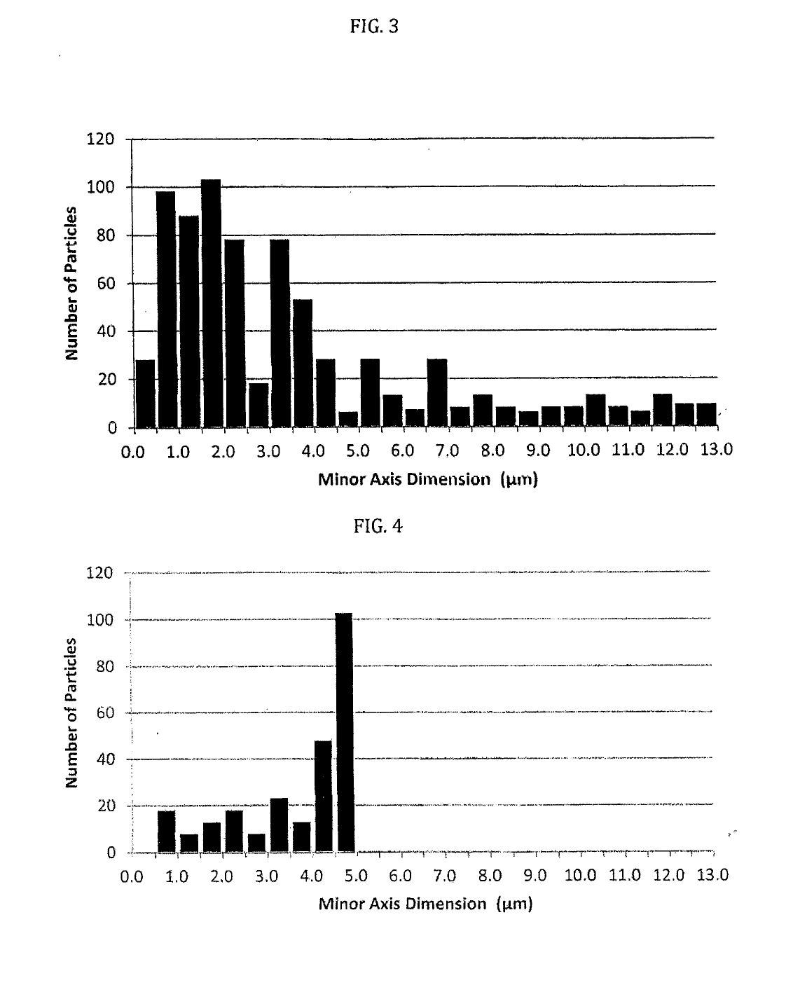

The resulting microstructure produced by the process described in Example 2 is illustrated in FIG. 2. Although particles with a range of geometric parameters also exists here, just as in FIG. 1, the population of particles with a minimum minor axis and aspect ratio is significantly reduced. It is possible to quantify the geometric parameters of a given coating by analyzing cross sections of full circumference views at high magnification (≈1000×) using standard optical metallographic procedures. Five such random cross sections were prepared from Sample 1 produced using the process of Example 1 and Sample 2 produced using the process of Example 2. The analyzes of these cross sections are summarized in FIGS. 3 and 4 which represent histograms of the minor axis dimension respectively for Samples 1 and 2. Further analysis of the minor axis dimension distribution is presented in Table 1 below where the aspect ratio is defined as aspect ratio=(minor axis dimension)/(major axis dimension).

TABLE 1

| | Sample 1 | Sample 2 |
|---|---|---|
| | (1.2 mm conversion) | (0.4 mm conversion) |
| Gamma Particles with | 29.9% | 8.9% |
| minor axis equal to or | | |
| less than 1.5 μm | | |
| Gamma Particles with | 75.9% | 35.6% |
| minor axis equal to or | | |
| less than 4.0 μm | | |
| Gamma Particles with | 5.1% | 17.8% |
| with aspect ratio equal | | |
| to or greater than 5.0 | | |

The major difference between the processes employed in Examples 1 and 2 is the amount of cold work the intermediate continuous gamma phase coating is subjected to during the cold drawing to its final diameter. The cold work imposed on Sample 1 created multiple fractures in the intermediate coating and to some degree pulverized it as evidenced by the high percentage of particles with a minor axis equal to less than 1.5 μm. Clearly Sample 2 has a) fewer fines and b) larger average sized particles with a tighter distribution and significantly higher aspect ratio as evidenced by FIGS. 4 and 5 and Table 1. Indeed Sample 1 does have some particles with larger minor axis dimension, but the aspect ratio of those particles typically has a value of 1.0 to 1.5. Higher aspect ratio particles are important because they present a more uniform zinc concentration profile to the workpiece. The existence of fines is important because they are the most likely source of debris which characterizes the “dirty wire” that complicates costly machine tool maintenance. This fact has been demonstrated by performing a simple test using the apparatus schematically illustrated in FIG. 5. In the test a measured length of wire (of the order 1-2 km) is pulled at approximately 200 m/min through a sandwich composed of felt pads and special wiping papers. A cross section of the felt/paper sandwich which measures 6 cm×10 cm is illustrated in FIG. 5. The wiping paper is made by a proprietary process and commercially available from. Boyd Technologies Inc., South. Lee, Mass. (www.boydtech.com) and was developed for a wire cleaning system. A 3 kg weight is placed on top of the felt/paper sandwich prior to commencing the test. The weight of the wiping papers in a given sandwich was accurately determined using a four place electronic analytical balance (Sartorius Model ED124S, 120 gm×0.1 mg) prior to and subsequent to a given determination and a cleanliness rating assigned by dividing the net increase in weight by the length of wire used and the values reported as mg/1000 m. Table 2 presents the results of tests performed on Samples 1 and 2.

TABLE 2

| | |
|---|---|
| Sample 1 (1.2 mm conversion) | 6.0 mg/1000 m |
| | 6.5 mg/1000 m |
| | 6.1 mg/1000 m |
| Sample 2 (0.4 mm conversion) | 0.1 mg/1000 m |
| | 0.2 mg/1000 m |
| | 0.2 mg/1000 m |

Sample 2 is demonstrably cleaner than Sample 1 as evidenced by the dramatically low residual debris adhering to the wiping paper.

Performance tests were conducted on Samples 1 and 2 by making test cuts on an Agie DEM-250 upgraded to TechStar Fast Track 2.1 Caliber using the following parameters:

| Material | 2 inch thick D-2 Tool Steel R_{c} 60-62 | |
|---|---|---|
| Water Temp | 70° | F. |
| Flush Pressure | 220 | psi |
| Conductivity | 15 | US/cm |
| Wire Diameter | 0.25 | mm |
| Wire Speed | 135 | mm/sec |
| Wire Tension | 1150 | gms |

| | |
|---|---|
| On-Time | 1.15 |
| Peak Current | 3 |

The result of the performance tests are presented in Table 3 below.

TABLE 3

| Sample | Cutting Speed |
|---|---|
| 1 (1.2 mm conversion) | 11.6 sq in/hr |
| 2 (0.4 mm conversion) | 11.5 sq in/hr |

The cutting speed of both Samples 1 and 2 are statistically equivalent even though Sample 1 had particles with larger minor axes dimensions than Sample 2. Clearly the minor axes dimensions of the samples have little effect on their cutting speeds but have a major effect on the cleanliness of the wire. As previously pointed out, cleanliness is also very important in the performance of EDM wires because it can significantly reduce the operating cost of a machine tool by decreasing maintenance time thereby increasing productivity.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. An electrode wire for use in an electric discharge machining apparatus, said wire comprising:
a core comprising one of a metal, an alloy of a metal, and a metallic multilayered composite;
a coating disposed on said core, said coating comprising distinct particulate of a brittle alloy, said particulate possessing a range of the geometric parameters major axes, minor axes, and aspect ratio where the term aspect ratio is defined by the quotient of the division of the major axis dimension by the minor axis dimension,
a distribution of the said geometric parameters determined by five full circumference random optical metallurgical cross sections at a magnification of a minimum 1000× contains a maximum 15% number of particles with a minor axis equal to or less than 1.5 μm and a minimum 10% number of particles with an aspect ratio equal to or greater than 5.0.

2. The electrode wire of claim 1, wherein said core is copper.

3. The electrode wire of claim 1, wherein said alloy core is brass.

4. The electrode wire of claim 1, wherein said metallic multilayered composite core is a copper core with an outer layer of beta phase brass.

5. The electrode wire of claim 1, wherein said metallic multilayered composite core is an alpha phase brass core with an outer layer of beta phase brass.

6. The electrode wire of claim 1, wherein said metallic multilayered composite core is a steel core with an intermediate layer of copper and an outer layer of beta phase brass.

7. The electrode wire of claim 1, wherein said metallic multilayered composite core is a steel core with a first intermediate layer of copper a second intermediate layer of alpha phase brass and an outer layer of beta phase brass.

8. The electrode wire of claim 1, wherein said coating is gamma phase brass.

9. An electrode wire for use in an electric discharge machining apparatus, the wire comprising:
a) a core comprising one of the following: a metal, an alloy of a metal or a metallic multi-layered composite,
b) a coating disposed on said core, said coating comprising a particulate of a brittle alloy, said particulate having geometric parameters including major axes, minor axes and an aspect ratio, said aspect ratio being defined by the quotient of a major axis dimension divided by a minor axis dimension;
c) a distribution of said geometric parameters being determined by five full circumference random optical metallurgical cross sections that are taken at a magnification of a minimum one-thousand times and having a maximum 15% of the number of particles with a minor axes equal to or less than 1.5 μm and a minimum 10% of the particles having an aspect ratio equal to or greater than 5.0 [symbol]
